(19) United States
(12) Patent Application Publication
(10) Pub. No.: US 2008/0157515 A1
(43) Pub. Date: Jul. 3, 2008

(54) BOOK AND ALBUM COVER

(76) Inventor: Alexander Milford, Carson City, NV (US)

Correspondence Address: PETER JAMES TORMEY, 2017 ESPERANZA DRIVE, CONCORD, CA, 94519, US

(21) Appl. No.: 11/965,573

(22) Filed: Dec. 27, 2007

Related U.S. Application Data
(60) Provisional application No. 60/878,297, filed on Jan. 3, 2007.

(51) Int. Cl. B42D 3/00; B65D 69/00; B42C 7/00

(52) U.S. Cl. 281/29; 206/575; 412/3

(57) ABSTRACT

A kit comprising one or more portions of binder's board having a top and bottom surface; one or more portions of adhesive paper coated on each side with a pressure sensitive adhesive; release paper adhered to each side of the adhesive paper so that the release paper can be easily removed exposing the pressure sensitive adhesive; and a hinge board. Also a method for forming the same.

This application claims the benefit of U.S. Patent Application 60/878,297 “Book and album cover” filed on Jan. 3, 2007 which is incorporated herein by reference.

### BACKGROUND

The present invention relates generally to albums and book covers, and more particularly to an album that allows users to use their own covering material.

The art of book covering has been around for many years; however, until recently, a person who wanted a custom photo album or other type of book cover was limited to either those that were commercially available or to having to build their own from their own expertise. In recent years there has been a renewed interest in bound photo albums with the advent of the digital camera. Consequently more people are engaged in scrap booking and other forms of artistic expression.

As such, what is needed is a means for a person to make an album cover using material they select themselves without having to rely on commercially produced albums.

### SUMMARY

The present disclosure is for a system, method and kit comprising one or more portions of binder's board having a top and bottom surface; one or more portions of adhesive paper coated on each side with a pressure sensitive adhesive; release paper adhered to each side of the adhesive paper so that the release paper can be easily removed exposing the pressure sensitive adhesive; and a hinge board.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates an exploded diagram of one embodiment of the current invention.

FIG. 2 illustrates one aspect of the current invention showing a side profile view.

FIG. 3 illustrates another aspect of the current invention, folding the hinge board.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The current invention is for a system, method and kit for allowing a person to construct their own album using a cover material of their choice.

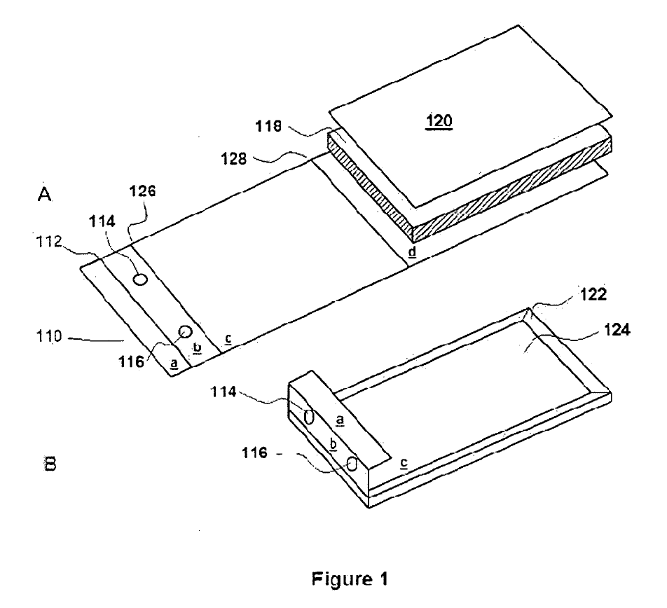

FIG. 1 illustrates one embodiment of the current invention. FIG. 1 (A) shows an exploded diagram of one half of an album cover. FIG. 1(B) shows a completed half of an album cover. Both the top cover and the bottom cover are identical. The elements of the album cover are a cover material 122 which can be selected from any material pliable enough and of sufficient properties to adhere to a pressure sensitive adhesive (PSA). Item 110 is a hinge board comprised of four parts a, b, c and d. Each part is constructed from binder's board. The four parts are connected by three hinges 112, 126 and 128 said hinges being constructed from adhesive tape (not shown) adhered to both sides. The hinges 112, 126 are constructed to provide a stiff hinge action whereas hinge 128 is constructed to allow part d to fold back under part c. A section of foam 118 is affixed to part d of the hinge board and a piece of board stock 120 is affixed to the foam 118. The foam 118 and board stock 120 are substantially the same width and length of part d of the hinge board 110 which in turn is sized to approximately the size of the desired album. Perforations 114 and 116 are constructed in the hinge board part b. FIG. 1(B) shows the completed assembly for half of an album cover with a cover material 122 folded in place over hinge board part c. The cover material, which can be selected from any material pliable enough and of sufficient properties to adhere to a pressure sensitive adhesive (PSA), is affixed to a piece of “double stick” material (not shown) described below.

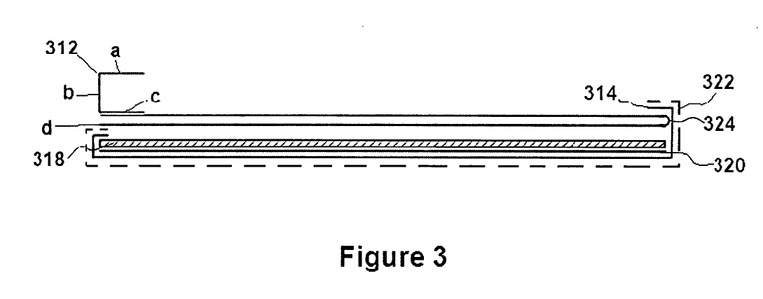

In view of the foregoing, FIG. 3 shows a profile drawing of a hinge board 312 used in the embodiment of FIG. 1. The hinge board is made from board stock of sufficient weight and strength to support binding the album, but pliable enough to allow for folding. The hinge board may be manufactured from a single piece of board stock or from separate pieces held together by the hinges described above. In the figure part d is shown folded back under part c by the action of hinge 324 of the hinge board 312. Part d may be held to part c by double stick (not shown). A section of double stick 314 is shown encasing the hinge 324 and in turn encasing the board stock 320 and foam section 318 at the opposite end. A cover material 322 is affixed to the double stick 314 such that the cover material 322 forms an outer cover to the album.

One having skill in the art would recognize that double stick may be made by coating a piece of paper with PSA on both the top and the bottom sides. The double stick would normally be supplied with release paper over the PSA area so that a user can remove the release paper and gain access to the PSA. Also the double stick may have markings to facilitate cutting and folding the double stick to provide for ease of construction. Also one having skill in the art would recognize that the hinges may be made by creasing a piece of board stock so that the hinge board 312 is constructed from a single piece or the hinges may be made from tape such that the hinge board 312 is comprised of two or more pieces taped together to form the hinge board 312. One having skill in the art would also appreciate that it would be within the spirit of the invention to construct the album without hinge 324 by having part c and d held together with double stick. Also the foam section 318 is not required to effect the invention.

To assemble the album cover, the release paper is removed from one side of double stick 314 and the double stick is adhered to the cover material 322. Then the hinge board 312 is folded according to FIG. 3 and the release paper is removed form the other side of the double stick 314 and adhered to the hinge board as shown in FIG. 3. Parts c and d are held together with a small amount of double stick such that a slight clearance is allowed between them at the end near parts a and b of the hinge board 312. Excess cover material and double stick may be trimmed off.

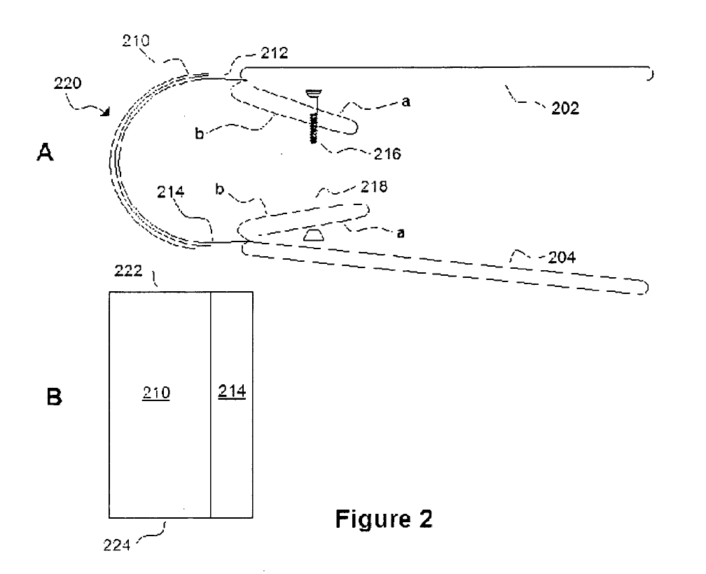

FIG. 2 shows an exploded diagram of the album with construction details. The top cover 202 has parts a and b, which are part of the hinge board, folded back and a post screw 216 is placed through the perforation (not shown). The bottom cover 204 has parts a and b, which are part of the hinge board, folded back and a post screw receptacle 218 is placed through the perforation (not shown). By screwing the post screw 216 into the post screw receptacle 218, any number of pages may be inserted between the part b of the upper cover 202 and the part b of the bottom cover 204 as long as the length of the post screw and post screw receptacle are sufficient.

A spine cover 220 may be made from a cover material 210, an adhesive paper 212 covered with PSA and board stock 214. The board stock 214 is cut to fit in the spacing between part c and d of the hinge board leaving enough extra length to fold over between the two covers. The release paper is removed from a first side of the adhesive paper 212 and the adhesive paper is adhered to a first side of the board stock 214. The release paper is removed from a second side of the adhesive paper 212 and the cover material 210 is adhered to the second side of the adhesive paper 212. Note that in this embodiment the cover material does not completely cover the board stock 214 as shown in FIG. 2(B); however, excess cover material 210 may fold over the top edge 222 and bottom edge 224 of the board stock 214 Once assembled the spine cover 220 can be inserted into the top cover 202 and the bottom cover 204.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A kit comprising:
one or more portions of binder's board having a top and bottom surface;
one or more portions of adhesive paper coated on each side with a pressure sensitive adhesive;
release paper adhered to each side of the adhesive paper so that the release paper can be easily removed exposing the pressure sensitive adhesive; and
a hinge board.

2. The kit of claim 1 further comprising printed instructions.

3. A method comprising the steps of
applying pressure sensitive adhesive to a top and bottom surface of a first piece of paper;
adhering the bottom surface of the first piece of paper to a portion of a first binder's board, said first binder's board having at least one hinge section;
adhering a textile material to the top surface of the first piece of paper;
applying pressure sensitive adhesive to a top and bottom surface of a second piece of paper;
adhering the bottom surface of the second piece of paper to a portion of a second binder's board, said second binder's board having at least one hinge section;
adhering a textile material to the top surface of the second piece of paper; and
joining the first and second binder's boards together with a fastener wherein the top surfaces of each binder's boards form a book cover.

4. The method of claim 3 wherein the fastener is a threaded binding post and the first and second binder's board each has at least one through hole for receiving the binder's board.

5. A book cover comprising the following:
at least one portion of binder's board having a top and bottom surface;
at least one portion of adhesive paper coated on each side with a pressure sensitive adhesive;
release paper adhered to each side of the adhesive paper so that the release paper can be easily removed exposing the pressure sensitive adhesive; and
a hinge board.

6. The book binding of claim 5 further comprising one or more threaded binding post fasteners.
